(19) United States
(12) Patent Application Publication
(10) Pub. No.: US 2010/0250653 A1
(43) Pub. Date: Sep. 30, 2010

(54) Method and system for providing cross-domain communication

(76) Inventors: Brandon Hudgeons, Austin, TX (US); Michael Bachers, Austin, TX (US); Jason Bennett, Austin, TX (US); Jack Schaedler, Albuquerque, NM (US)

Correspondence Address: Raymond M. Galasso;Galasso & Associates, L.P., P.O. Box 26503, Austin, TX, 78755-0503, US

(21) Appl. No.: 12/657,976

(22) Filed: Jan. 28, 2010

Related U.S. Application Data
(60) Provisional application No. 61/206,352, filed on Jan. 29, 2009.

(51) Int. Cl. G06F 15/173; G06F 15/16

(52) U.S. Cl. 709/203; 709/226

(57) ABSTRACT

A method performs an operation for utilizing programming interface functionality of a first domain for accessing a remote resource of a second domain different than the first domain. Thereafter, the method performs an operation for providing the remote resource to a system having requested the remote resource. Provide the remote resource includes providing the remote resource through the first domain utilizing client-side services of said programming interface functionality.

### CROSS REFERENCE TO RELATED APPLICATIONS

This patent application claims priority from co-pending United States Provisional Patent Application having Ser. No. 61/206,352; filed 29 Jan. 2009; entitled “Application Programming Interface Software”, having a common applicant herewith and being incorporated herein in its entirety by reference.

### FIELD OF THE DISCLOSURE

The disclosures made herein relate generally to enabling cross-domain Internet communication, more particularly, to enabling cross-domain communication between Internet content and server APIs such as SCORM-complaint and AICC-compliant learning management systems.

### BACKGROUND

Internet applications are typically served as a mix of HTML, JavaScript, CSS, Adobe Flash files, and other files and formats. A web browser takes these files, delivered by the server in response to an HTTP request (or similar protocol request), and executes them within the browser, thus delivering the server's content and functionality to the user. In the early days of the Internet, these files and other information were stored as static files on the server, and the server merely accessed and delivered the files to web browser clients upon request. More recently, it has become common for web servers to deliver both static files as well as files that were constructed by web server software on-the-fly, customized to the user's specific requirements or session state. Even so, all static files and application logic for serving a web browser's request typically resided on one server, or at least within a cluster of servers that were all working together to satisfy the requests sent to a given Internet domain (i.e., network domain). Internet domain refers to a realm of administrative autonomy, authority, or control in the Internet. Internet domains are identified by names in accordance with the Domain Name System (DNS), which is a hierarchical naming system for computers, services, or any resource connected to the Internet or certain private networks.

In current-day web applications, it is much more common that a given application will access content, data and functionality from multiple, distributed sources (i.e., hybrid applications). For example, a web application can allow users to post items that include videos hosted on other web domains, like YouTube, thus creating a compound page. Or, a financial news website might pull real-time financial data from another web application so that news articles that reference a company might be accompanied by a real-time stock quote for that company. As these kinds of hybrid applications became more popular, web application and information providers began to provide and support Application Programming Interfaces that make integration of web application services easier and faster. An application programming interface (API) is an interface implemented by a software program to enable interaction with other software. An API is an abstraction that defines and describes an interface for the interaction with a set of functions used by components of a software system. The software that provides the functions described by an API is said to be an implementation of the API. One result was the “mashup”, which is a web application that combines data and/or functionality from more than one source (e.g., more than one domain).

The creation of hybrid applications has become relatively common and straightforward for the typical scenario where the web application designer makes use of an API that allow a server-side application to pull content, data and functionality from other web domains, combine them with its own content, data and functionality, and then deliver the combined application and/or content to web clients. Simple embedding of discrete content and functionality such as, for example, images, videos or plug-in-enabled applications like Adobe Flash applications are simple, straightforward and common as well.

One specific type of hybrid application remains challenging. As web browser security models have matured, almost all of them have established and subsequently strengthened “same origin” security policies in response to cross-site scripting (XSS) attacks. These prohibitions prevent executable code (e.g., JavaScript) from injecting, controlling and/or accessing executable code originating from a different domain than the executable code itself. For a web application designer who completely controls the server environment, this restriction is rarely problematic because there is no same origin security policy with respect to server-side code, thereby allowing the server application to access third-party services at will and combine them in any way necessary to support application goals and requirements. However, the web application cannot typically construct a web application that will cause the user's browser to perform the act of contacting and communicating with executable code that the browser must access from a different domain. For the above referenced security reasons, browsers now enforce a strict separation between content provided by different domains (i.e., same origin security policy).

Same origin security policy can cause significant problems for at least two classes of online applications. The first one of these classes of online applications includes applications where a web application designer does not fully control the server-side environment. The second one of these classes of online applications includes applications where the application designer does not fully control the domain from which an application will be launched and/or served.

For such first class of online application, a web application designer sometimes does not fully control or otherwise have access to the server environment and, thus, may be restricted on the ability to connect to cross-domain services only on the server. An example of this is an application developer who creates a web application that will be deployed in a shared hosting environment. Such a developer may have limited rights or knowledge to use certain services of the server and may have little or no access to server-side programming services or ability. Such a developer would like to be able to write, for example, JavaScript that executes within the browser client that accesses the needed content or functionality, rather than writing and executing server-side code to accomplish the same goal. To this end, designers of APIs to service these types of applications have developed interesting and useful approaches for supporting this goal. One example of these approaches is JavaScript Object Notation (JSON), which is a lightweight data-interchange format. Another example of these approaches, which is implemented by Facebook and other heavily-used APIs, includes a mechanism involving hidden iFrames and uniform resource locator (URL) fragments to achieve cross-domain communication. Generally speaking, an iFrame refers to an HTML document embedded inside another HTML document on a website. It should be noted that browser plug-ins can and do implement certain mechanisms for achieving cross-domain communication. For example, Adobe Flash allows servers to allow cross-domain communication across Flash objects via a cross-domain policy file.

For such second class of online applications, the web application designer will have full access to the server environment, but the application must be launched from and integrate with a separate server-side environment on a different domain. An example of this is a web application that needs to launch within and integrate with an enterprise content management system of some kind. The application must launch from and communicate with the domain serving the content management system, but the web application designer actually controls the server environment of an entirely different domain. This type of situation is particularly common in the case of legacy architectures, specifications, protocols and applications that were originally designed in a manner where content and functionality of a web application were assumed to reside within a single server-side environment. Specific example of this second class of online applications includes Sharable Content Object Reference Model (SCORM) and Aviation Industry CBT (Computer-Based Training) Committee (AICC). SCORM refers to a collection of standards and specifications for web-based e-learning and defines communications between client side content and a host system called the run-time environment, which is often implemented by a learning management system (LMS). (AICC) refers to standards for web-based e-learning applications and is an international association of technology-based training professionals that develops training guidelines for the aviation industry. These standards expect that a single compressed archive of static files will be loaded into the SCORM-compliant or AICC-compliant LMS server, where the archive will be unpacked and served to web browsers upon request. SCORM-compliant and AICC-compliant web applications typically must communicate with the SCORM-compliant or AICC-compliant LMS server via a JavaScript object. If the web application is served from a different domain than the LMS, browser same-origin policies normally prevent such communication.

It is known that in the aforementioned types of server-side environments, and in SCORM and AICC environments in particular, several workarounds have been proposed and implemented for overcoming adverse issue resulting from same origin security policy. However, such workarounds exhibit drawbacks that limit their effectiveness and/or desirability. For example, some of these workarounds rely upon client browser configuration or exploitation of browser security holes that have since been rectified and some workarounds require LMS server configuration or participation in the communication scheme, which generally make such workarounds ineffective and/or undesirable. It is also recognized that various standards bodies such as, for example, the International Federation for Learning-Education-Training Systems Interoperability (LETSI)), which is primarily responsible for the SCORM standard, recognize the disadvantages of such workarounds and are, therefore, still in need of a preferred solution to the associated problems.

### SUMMARY OF THE DISCLOSURE

Embodiment of the present invention are configured for providing communication across domains (i.e., network domains) between web applications and server-side functionality, including server-side APIs. More specifically, embodiments of the present invention advantageously overcome one or more shortcomings associated with conventional approaches for resolving adverse issues related to same origin security policies as applied to cross-domain communication. To this end, embodiment of the present invention allow a web service provider to provide access to defined web services to application developers, and specifically to allow designers of SCORM-like and/or AICC-like standards compliant packages with the ability to allow their remote domain applications to access and communicate with LMS domain objects and services. Furthermore, embodiment of the present invention can also be applied to situations where a designer of web services wants to make desired remote-domain services available as if they were local to an environment of the application designer or end-user.

In one embodiment of the present invention, a method begins with at least one data processing device accessing, from memory coupled to said at least one data processing device, instructions causing said at least one data processing device to utilize programming interface functionality of a first domain for accessing a remote resource of a second domain different than the first domain. Thereafter, said at least one data processing device performs an operation for accessing, from said memory, instructions causing said at least one data processing device to provide the remote resource to a system having requested the remote resource. Causing said at least one data processing device to provide the remote resource includes causing said at least one data processing device to provide the remote resource through the first domain utilizing client-side services of said programming interface functionality.

In another embodiment of the present invention, a client-server system comprises at least one data processing device, instructions processable by said at least one data processing device, and an apparatus from which said instructions are accessible by said at least one data processing device. The instructions are configured for enabling said at least one data processing device to facilitate utilizing an application programming interface of a first domain for accessing an application of a second domain different than the first domain and to facilitate providing the application to a client system. Providing the application includes providing the application through the first domain utilizing client-side services of said programming interface functionality.

In another embodiment of the present invention, a computer-readable medium having tangibly embodied thereon and accessible therefrom a set of instructions interpretable by at least one data processing device. The set of instructions is configured for causing said at least one data processing device to carry out operations for utilizing an application programming interface of a first domain for accessing an application of a second domain different than the first domain and for providing the application to a client system. Providing the application includes providing the application through the first domain utilizing client-side services of said programming interface functionality.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a block diagram view showing a first embodiment of an application development and deployment implementation configured in accordance with the present invention.

FIG. 2 is a block diagram view showing a second embodiment of an application development and deployment implementation configured in accordance with the present invention.

FIG. 3 is a block diagram view showing a first preferred embodiment of performing cross-domain communication using API remote code functionality in accordance with the present invention.

FIG. 4 is a block diagram view showing a second preferred embodiment of performing cross-domain communication using API remote code functionality in accordance with the present invention.

FIG. 5 is a block diagram view showing a third preferred embodiment of performing cross-domain communication using API remote code functionality in accordance with the present invention.

FIG. 6 is a block diagram view showing a fourth preferred embodiment of performing cross-domain communication using API remote code functionality in accordance with the present invention.

### DETAILED DESCRIPTION OF THE DRAWING FIGURES

Embodiments of the present invention advantageously provide for cross-domain communication by APIs. Specifically, instead of launching API-domain services and web applications on separate domains (e.g., network domains) and requiring mechanisms to get around same-origin policy restrictions, embodiment of the present invention provide a mechanism whereby one or more API data structures (e.g., API objects) provide for execution of remote code (i.e., an application) within the API's domain (i.e., API remote code functionality). In other words, an API provider would give developers who want to integrate their code (e.g., remote resource such as an application) with the provider's API a mechanism to have the API locate the remote code and, once accessed, serve and execute that remote code (e.g., remote resources and/or assets thereof) from within the API's domain instead of within the domain of the remote code developer. That way, the remote code would have direct access to API capabilities without needing to rely on the cross-domain scripting techniques described above. In the case of a SCORM-complaint or AICC-compliant server, a properly configured generic content package can add this functionality to the LMS server without further LMS server-side coding or configuration. A package is defined herein to include a data structure including information therein accessible by a data processing device or process.

Cross-domain communication carried out in accordance with the present invention can be implemented through various approaches using, for example, browser plug-in technology that offers a method for cross-domain communication (e.g., Adobe Flash and its cross-domain policy file) or using standard browser technologies (e.g., JavaScript and URL manipulation). In one implementation of the present invention, an API domain provides server-side programming (e.g., an API data structure) that loads in remote resources (e.g., an application and/or information derived therefrom) dynamically and serves them to users along with its own local API capabilities. In this case, the remote code has direct access to the API object(s). Additional programming instructions alter links in the remote application so that the user is sent to the proper (API domain) location instead of to the remote application domain, and references to other application resources or functionality can be dynamically re-written to maintain proper application references and state. In another implementation of the present invention, the API domain can load the remote application into a window or frame that still loads directly from the remote domain, but that is supplemented by enabling technologies that support communication from the remote domain to the API domain in a way that mimics local access to the API object (i.e., a mirror object). This mirror object can be instrumented statically to provide API services and/or can be built dynamically via introspection of the remote API object. Such a mixture of both static and dynamic application is particularly useful to provide immediate initialization and baseline and/or bootstrap services to the remote application while the initialization and introspection process completes.

These implementations for carrying out cross-domain communication are particularly useful for providing online applications with functionality that supports communication with a SCORM-compliant or AICC-compliant LMS. Thus, in one embodiment of the present invention, such embodiment includes a SCORM-compliant package (e.g., software) or AICC-compliant package that contains a Flash application and, optionally, supporting Javascript code that launches from the LMS domain, establishes communication with the LMS API object, loads an external Flash application and facilitates communication between the external Flash application and the API object. In another embodiment of the present invention, such embodiment includes a SCORM-compliant or AICC-compliant package that contains a generic Javascript wrapper that works with supporting generic page on an external content server that creates a mirror object within the external content server that an API object can access directly. The mirror object can communicate with the API object via a mechanism such as disclosed above (e.g., JSON-P, URL manipulation of iFrames, or Adobe Flash objects with cross-domain policy support). The external content server can communicate directly with the mirror object as if the mirror (i.e., remote) object were local. Preferably, a utilized framework handles such communication(s) transparently. Furthermore, a domain that serves the API object and that loads and executes the remote application code must be mindful of the fact that the intent of doing so is to side-step the browser's same origin security policy. As such, embodiments of the present invention are preferably implemented with remote domain trust policies and/or sandboxing technique (e.g., a restricted environment in which certain functions are prohibited thereby providing limitations on what system resources an application can request or access).

Embodiments of the present invention can include a web server that serves resources from a domain that provides access to certain software services. Examples of such software services include but are not limited to calculation, database, or communication services. For illustration purposes, the domain from which the web server that serves resources will be referred to herein as “apidomain.com”. A remote application developer that desires to deploy a static or dynamic web browser application on a different domain, which will be referred to herein as “application.com” that will connect to and utilize the services provided by one or more objects from apidomain.com. It is assumed that the remote application developer desires or is required to implement the connection to apidomain.com without utilizing standard server-side techniques. Examples of reasons for which the remote application developer desires or is required to implement the connection to apidomain.com without utilizing standard server-side techniques include, but are note limited to, the remote application developer being unqualified to do so, application.com being hosted by another party who does not provide or authorize server-side capabilities, or it is otherwise inconvenient or ineffective to do so.

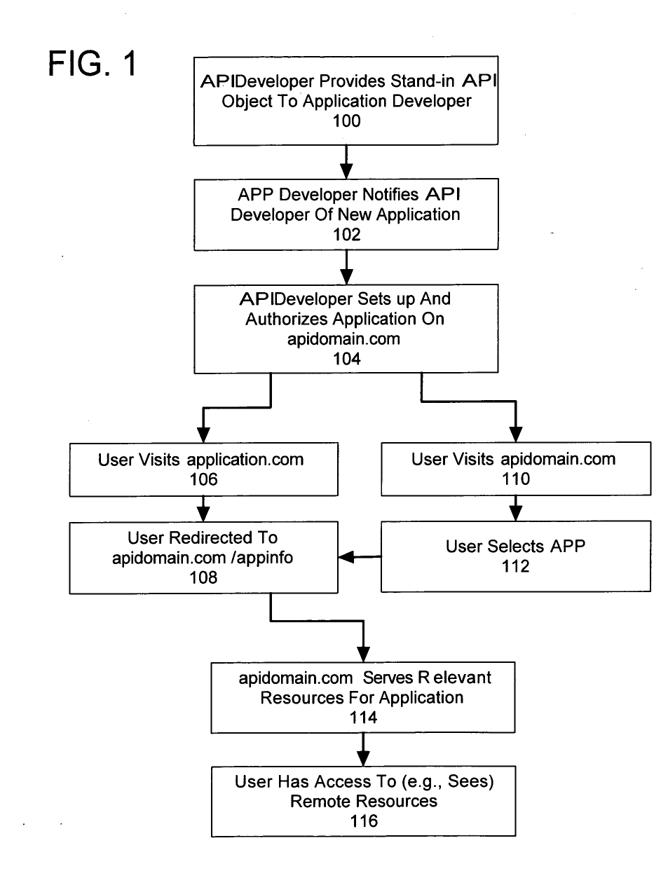

In a first embodiment of developing and deploying API remote code functionality in accordance with the present invention, as shown in FIG. 1, an API developer provides an application developer (block 100) with a local stand-in API object (i.e., an API data structure) that the application developer can use during application development, debugging and testing of an application (i.e., application data structure). One example of provides the application developer with the local stand-in API object includes transmitting the local stand-in API object using a downloadable SWF (small web format) file, which is an example of an executable file. When the application is complete, the application developer notifies the API developer (block 102) that the application is available and ready to be served. One example of notifying the API developer that the application is ready to be served includes using an online developer registration and verification process that also accounts for security via trust and sand boxing. Another example of notifying the API developer that the application is ready to be served includes using an automated or manual upload of a file containing metadata, such as an XML configuration file, that informs a software system controlling apidomain.com of the availability, location, and other identifying or descriptive information about the application. After serving of the application is enabled (block 106), an application user can access the application using a web browser. The web browser can be launched to a URL on application.com (block 106) and be redirected automatically (i.e., without further user action) to apidomain.com (block 108) or can be redirected in response to the user visiting apidomain.com (block 110) and selecting a provided link (block 112) that causes redirection to apidomain.com. The browser request to apidomain.com contains information that identifies the request as a request for the application from application.com. Preferably, identifying that the request is a request for the application from application.com is made directly by the URL code. Alternatively, identifying that the request is a request for the application from application.com can be performed via an HTTP post, by a cookie, or other suitable methods or by separate action of the user after receiving a menu of applications available to apidomain.com. The server running at apidomain.com then responds to the request by serving (block 114) the appropriate resources (e.g., file(s)) as described in at least one of the enumerated embodiments. Thereafter, the user has access to (block 116) the remote resources (e.g., the application or resources/information derived therefrom and/or associated therewith).

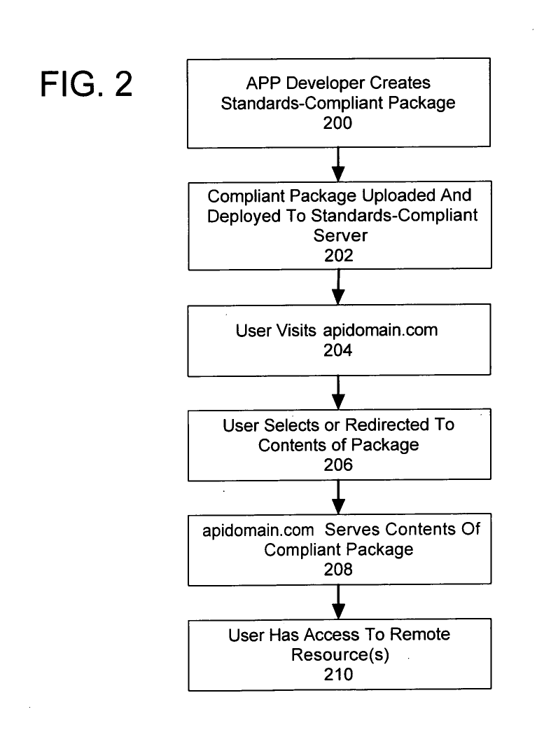

In a second embodiment of developing and deploying API remote code functionality in accordance with the present invention, as shown in FIG. 2, the application is designed to be deployed as a package compliant with SCORM, AICC or other similar web content (i.e., a compliant package) or web application packaging and metadata formats that load remote web applications and provide API communications. The application developer constructs a compliant package (block 200) that contains, along with other required descriptive and technical metadata, the information that the package needs to perform the act of loading the resources from the application.com domain. A SCORM.zip file is one example of such a compliant package. In a preferred embodiment, this information is the URL of the launch page of the remote application, passed to the package launch page via a URL attribute or fragment. The compliant package also contains the code necessary to load and run the application in accordance with an embodiment of the present invention (e.g., via one of the methods described below) so that the application.com resources have access to the apidomain.com API services, methods and data. This compliant package is delivered and uploaded to the compliant server (block 202). The compliant package (and the application) is then made available to users in the same manner that other types of packaged resources, thereby allowing a user (e.g., using its web browser) to visit apidomain.com (block 204). The user is then redirected to or selects contents of the package (block 206). Apidomain.com serves contents of the compliant package (block 208), including code (e.g., executable files) and references necessary to load and run the application from application.com. Such code and references are examples of remote resources. This development and deployment method is particularly useful for use with existing web pages and resources with SCORM, AICC or similar integration or reporting capabilities. Thereafter, the user has access to (block 210) the remote resources (e.g., the application or resources/information derived therefrom and/or associated therewith).

Presented now are several preferred embodiments of implementing API remote code functionality in accordance with development and deployment functionality disclosed herein. Such embodiments each provide a respective approach enable an API to provide for execution of remote code within the API's domain. In this manner, the remote code will have direct access to API capabilities without being adversely impacted by issues typically associated with cross-domain functionality.

### Preferred Embodiment 1

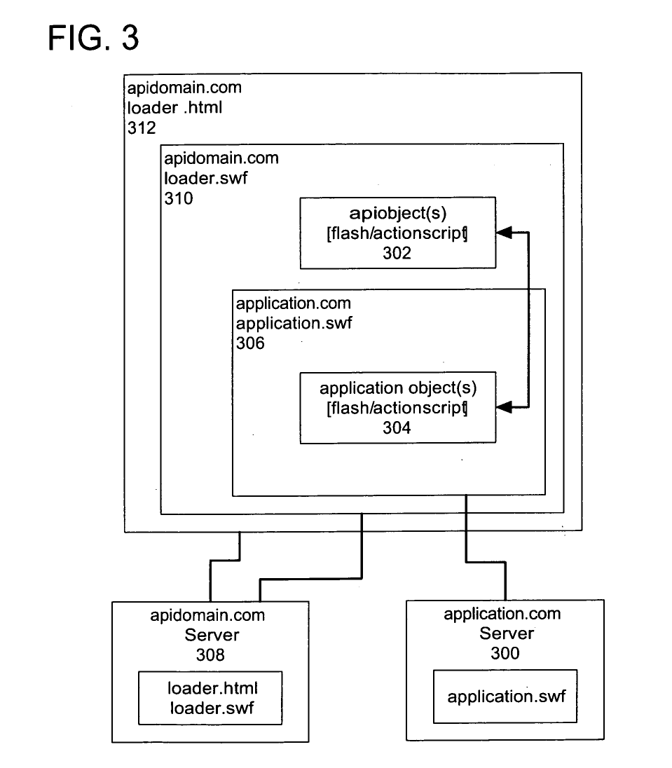

Referring to FIG. 3, a remote application developer creates and deploys an application on a server at application.com (block 300) in a format designed to be loaded and played by a browser plug-in that provides a mechanism for cross-browser communication. The application.com server is in a first domain. An API developer then exposes the application and/or services thereof (i.e., services provided by the application) on apidomain.com via one or more software objects (block 302) also implemented using the cross-browser (e.g., cross-domain) capable plug-in technology. The application can be embodied as a software object implemented in ActionScript (block 304) and deployed as a small web format (SWF) file (block 306) also sometimes referred to as a Shockwave Flash file. A server on apidomain.com (block 308) responds to a user's request for the application with a SWF (block 304) containing the API object(s) as well as code that loads and displays the SWF residing on application.com. The apidomain.com server is in a second domain. The user's web browser executes the application from application.com within a SWF (block 310) and/or the apidomain.com web page (block 312) served from apidomain.com, and the application.com SWF (block 306) has direct access to the API object(s) (block 302) though application objects (block 304). Communication between the apidomain.com objects and the remotely-loaded application.com objects are facilitated either via plug-in cross-domain policy file mechanisms or other plug-in mechanisms that support cross-domain communication or can be accomplished by having the apidomain.com server download and re-serve the application.com SWF file (e.g., through interaction between the apidomain.com server and the application.com server and through the application objects and application SWF being directly accessible to the apidomain.com server through apidomain.com domain via an application.SWF thereon).

### Preferred Embodiment 2

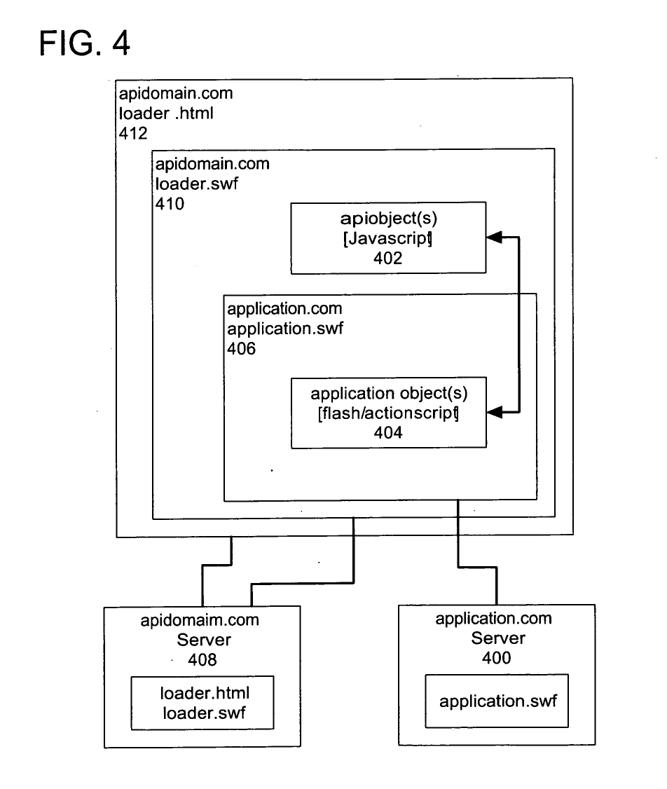

Referring to FIG. 4, a remote application developer creates and deploys an application on a server at application.com (block 400) in a format designed to be loaded and played by a browser plug-in that provides a mechanism for cross-browser communication (e.g., Adobe Flash). The application.com server is in a first domain. The API developer exposes the application and/or services thereof on apidomain.com via one or more software objects (block 402) also implemented using standard browser capabilities (e.g., via a JavaScript object). The application can be embodied as a software object implemented in ActionScript (block 404) and deployed as a small web format (SWF) file (block 406) also sometimes referred to as a Shockwave Flash file. A server on apidomain.com (block 408) responds to a user's request for the application with either a SWF that loads an application.com SWF, a page with code that embeds the application.com SWF and that provides for cross-domain communication, or a SWF downloaded and re-served by the apidomain.com server (e.g., through interaction between the apidomain.com server and the application.com server and through the application objects and application SWF being directly accessible to the apidomain.com server through apidomain.com domain via an application.SWF thereon). The apidomain.com server is in a second domain. The user's web browser then executes the application from application.com within a SWF (block 410) and/or apidomain.com web page (block 412) served from apidomain.com, and the application.com SWF has direct access to the JavaScript methods and objects necessary to access API services on the apidomain.com domain.

### Preferred Embodiment 3

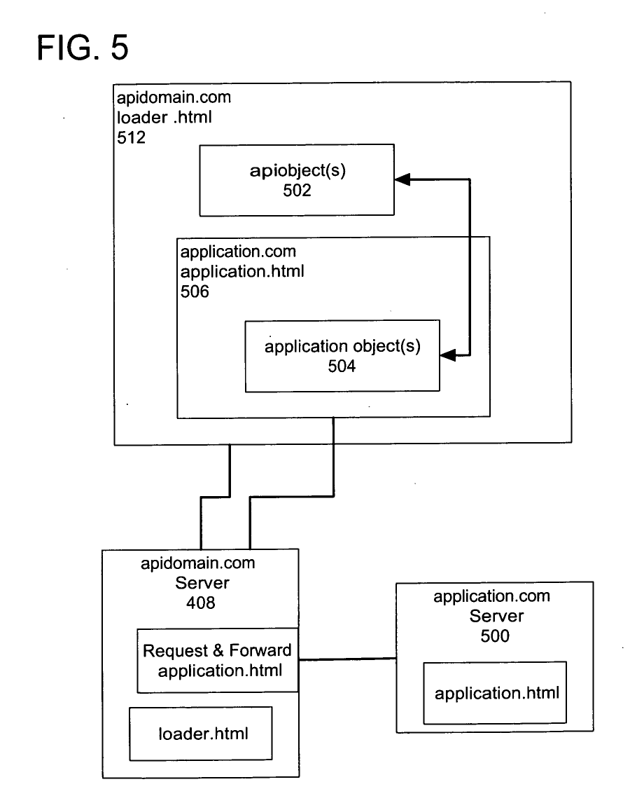

Referring to FIG. 5, a remote application developer creates and deploys an application on a server at application.com (block 500) using browser standard technologies such as, for example hyper text mark-up language (HTML), cascading style sheets (CSS), JavaScript and the like. The application.com server is in a first domain. An API developer exposes the application and/or services thereof on apidomain.com via one or more software objects (block 502) implemented using standard browser capabilities. Examples of such standard browser capabilities include, but are not limited to, a JavaScript object or other web service (e.g., Asynchronous JavaScript and XML (i.e., AJAX) mechanisms) hosted on apidomain.com. The application can be embodied as a software object implemented in application.com object (block 404) and deployed as html code (block 506) also sometimes referred to as a Shockwave Flash file. In response to a user's request for the application (e.g., via their web browser) through the apidomain.com web page (block 512), the apidomain.com server (block 508) pulls the application files and resources from the application.com server (block 500), re-instruments or re-writes any of the application code necessary (e.g., such as links), injects API object access code into the page or places API object(s) into a parent or child window or frame that the application objects may access, and serves the file to the web browser as if it were a resource from apidomain.com. In this manner, the web application thus has direct access to the API.

### Preferred Embodiment 4

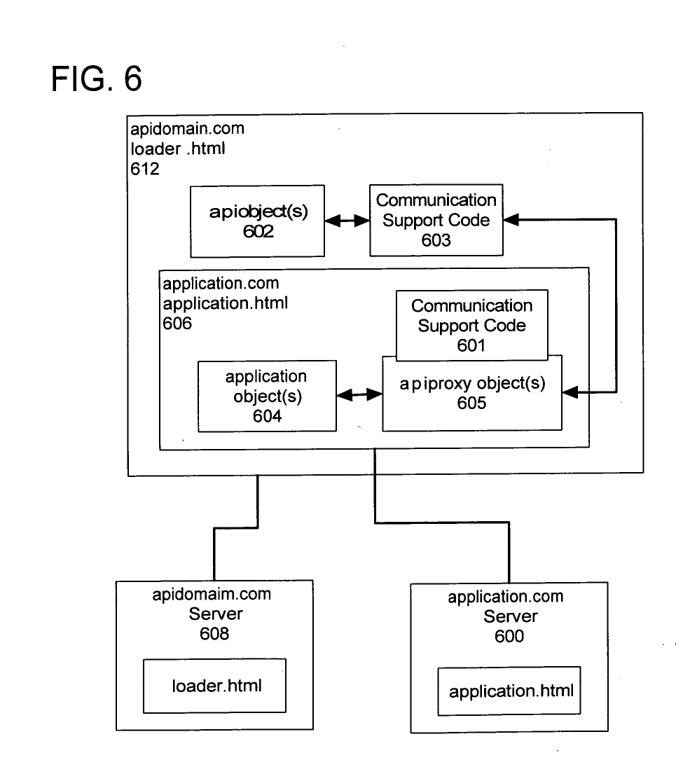

Referring to FIG. 6, an API developer provides an application developer with API code that must be deployed on a server of the application.com domain (block 600) to facilitate cross-domain communication. The application developer incorporates communication support code (block 601) into an application. Instead of pulling the application files and resources from the application.com server, in response to a user's request for the application, the API code (block 602) presents the web browser with a page that includes a frame or additional pop-up window and sets the URL of the frame or window to the appropriate application.com URL. Communication Support functionality in an enclosing or parent (i.e., apidomain.com) window or frame (block 603) working in conjunction with the provided code running in an enclosed or child (i.e., application.com) frame (block 601) provides the application with proxy API (block 605) that appear to the application exactly as if the application were running within the apidomain.com domain (block 612) even tough it is running in the application.com domain (block 606). Method(s), function(s) or object(s) are examples of such proxy objects. This functionality further facilitates communication between the proxy API and actual apidomain.com API (i.e., communication between block 602 and block 605), thereby allowing communication between api objects (block 602) and application objects (block 604). This proxy API is available immediately to the application to provide initialization functionality and is later supplemented dynamically with functionality from the apidomain.com services through the api.com server (block 608).

Referring now to instructions processable by a data processing device, it will be understood from the disclosures made herein that methods, processes and/or operations adapted for carrying out API remote code functionality as disclosed herein are tangibly embodied by computer readable medium having instructions thereon that are configured for carrying out such functionality. In one specific embodiment, the instructions are tangibly embodied for carrying out the functionality disclosed in reference to preferred embodiments 1-4 disclosed above and/or FIGS. 2-6. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon a computer program (i.e., instructions) adapted for carrying out API remote code functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method, comprising:
at least one data processing device accessing, from memory coupled to said at least one data processing device, instructions causing said at least one data processing device to utilize programming interface functionality of a first domain for accessing a remote resource of a second domain different than the first domain; and
said at least one data processing device accessing, from said memory, instructions causing said at least one data processing device to provide the remote resource to a system having requested the remote resource, wherein causing said at least one data processing device to provide the remote resource includes causing said at least one data processing device to provide the remote resource through the first domain utilizing client-side services of said programming interface functionality.

2. The method of claim 1 wherein causing said at least one data processing device to provide the remote resource includes causing said at least one data processing device to download the remote resource to the first domain and to serve the remote resource therefrom utilizing said client-side functionality thereby creating a same-domain environment in which said programming interface functionality and the remote resource can communicate.

3. The method of claim 2 wherein said programming interface functionality loads the remote resource using a browser plug-in that provides functionality for allowing cross-domain communication.

4. The method of claim 3 wherein:
the system includes a web browser;
causing said at least one data processing device to provide the remote resource includes causing the web browser to access the remote resources using an executable file of the second domain and web page served from the first domain; and
the executable file of the second domain has direct access to assets of said programming interface functionality.

5. The method of claim 1 wherein said programming interface functionality loads said remote resource using a browser plug-in providing functionality for allowing cross-domain communication.

6. The method of claim 1 wherein:
the system includes a web browser;
causing said at least one data processing device to provide the remote resource includes causing the web browser to access said remote resources using an executable file of the second domain and web page served from the first domain; and
the executable file of the second domain has direct access to resources of said programming interface functionality.

7. The method of claim 1 wherein:
a server on the first domain responds to the system with one of an executable file thereof that loads an executable file of the second domain, a webpage with an executable file that embeds the executable file of the second domain and that provides for cross-domain communication, and an executable file of the second domain that is downloaded to a server of the first domain and re-served by the server of the first domain.

8. A client-server system, comprising:
at least one data processing device;
instructions processable by said at least one data processing device; and
an apparatus from which said instructions are accessible by said at least one data processing device;
wherein said instructions are configured for enabling said at least one data processing device to facilitate:
utilizing an application programming interface of a first domain for accessing an application of a second domain different than the first domain; and
providing the application to a client system, wherein providing the application includes providing the application through the first domain utilizing client-side services of said programming interface functionality.

9. The client-server system of claim 9 wherein providing the application includes downloading the application to the first domain and serving the application therefrom utilizing said client-side functionality thereby creating a same-domain environment in which the application programming interface and the application can communicate.

10. The client-server system of claim 10 wherein the application programming interface loads the application using a browser plug-in that provides functionality for allowing cross-domain communication.

11. The client-server system of claim 11 wherein:
the client system includes a web browser;
causing said at least one data processing device to provide the application includes causing the web browser to access the applications using an executable file of the second domain and web page served from the first domain; and
the executable file of the second domain has direct access to assets of the application programming interface.

12. The client-server system of claim 9 wherein the application programming interface loads said application using a browser plug-in providing functionality for allowing cross-domain communication.

13. The client-server system of claim 9 wherein:
the client system includes a web browser;
providing the application includes causing the web browser to access said applications using an executable file of the second domain and web page served from the first domain; and
the executable file of the second domain has direct access to resources of the application programming interface.

14. The client-server system of claim 9 wherein:
a server on the first domain responds to the client system with one of an executable file thereof that loads an executable file of the second domain, a webpage with an executable file that embeds the executable file of the second domain and that provides for cross-domain communication, and an executable file of the second domain that is downloaded to a server of the first domain and re-served by the server of the first domain.

15. A computer-readable medium having tangibly embodied thereon and accessible therefrom a set of instructions interpretable by at least one data processing device, said set of instructions is configured for causing said at least one data processing device to carry out operations for:
utilizing an application programming interface of a first domain for accessing an application of a second domain different than the first domain; and
providing the application to a client system, wherein providing the application includes providing the application through the first domain utilizing client-side services of said programming interface functionality.

16. The computer-readable medium of claim 15 wherein providing the application includes downloading the application to the first domain and serving the application therefrom utilizing said client-side functionality thereby creating a same-domain environment in which the application programming interface and the application can communicate.

17. The computer-readable medium of claim 16 wherein the application programming interface loads the application using a browser plug-in that provides functionality for allowing cross-domain communication.

18. The computer-readable medium of claim 17 wherein:
the client system includes a web browser;
causing said at least one data processing device to provide the application includes causing the web browser to access the applications using an executable file of the second domain and web page served from the first domain; and
the executable file of the second domain has direct access to assets of the application programming interface.

19. The computer-readable medium of claim 15 wherein the application programming interface loads said application using a browser plug-in providing functionality for allowing cross-domain communication.

20. The computer-readable medium of claim 15 wherein:
the client system includes a web browser;
providing the application includes causing the web browser to access said applications using an executable file of the second domain and web page served from the first domain; and
the executable file of the second domain has direct access to resources of the application programming interface.

21. The computer-readable medium of claim 15 wherein:
a server on the first domain responds to the client system with one of an executable file thereof that loads an executable file of the second domain, a webpage with an executable file that embeds the executable file of the second domain and that provides for cross-domain communication, and an executable file of the second domain that is downloaded to a server of the first domain and re-served by the server of the first domain.
